(19) United States
(12) Patent Application Publication
(10) Pub. No.: US 2025/0296653 A1
(43) Pub. Date: Sep. 25, 2025

(54) MOUNTING BRACKET FOR ELECTRIC MOTOR

(71) Applicant: Honda Motor Co., Ltd., Tokyo (JP)

(72) Inventors: BENJAMIN D. MONINGER, MARYSVILLE, OH (US); MICHAEL JOSEPH KLUCHAR, PLAIN CITY, OH (US)

(21) Appl. No.: 18/613,976

(22) Filed: Mar. 22, 2024

(51) Int. Cl. B62K 5/01; B62M 7/00

(52) U.S. Cl. CPC B62K 5/01; B62M 7/00; B62K 2204/00

(57) ABSTRACT

An electric motor assembly for a vehicle includes an electric motor having a motor housing and a pair of engagement structures arrayed circularly around a circumference of the motor housing and attached to an outer surface of the motor housing. The electric motor assembly also includes a bracket removably coupled to the pair of first engagement structures and adapted to be removably connected to a frame of the vehicle.

### BACKGROUND

The disclosed subject matter relates to an electric vehicle. More particularly, the disclosed subject matter relates to an electric motor assembly having an electric motor and a bracket to suitably mount the electric motor to a frame of the electric vehicle.

As electric vehicles continue to become more popular, electric motor shapes and associated geometric features also change. Different motors transmit load and vibration to the vehicle frame in different manners. Accordingly, a mounting structure is needed that can facilitate the mounting of the various types of motors to the vehicle and effectively bears and transmits the load and vibrations to the frame.

### SUMMARY

In accordance with one embodiment of the present disclosure, an electric motor assembly for a vehicle is disclosed. The vehicle includes a frame. The electric motor assembly comprises an electric motor having a motor housing and a pair of engagement structures arrayed circularly around a circumference of the motor housing and attached to an outer surface of the motor housing. The electric motor assembly also includes a bracket removably coupled to the pair of first engagement structures and adapted to be removably connected to the frame.

In accordance with another embodiment of the present disclosure, a mounting assembly for mounting an electric motor to a frame of a vehicle is disclosed. The mounting assembly comprises a first mount attached to the frame and having a base, and a bracket including a base plate and a pair of sidewalls extending from the base plate and arranged spaced apart from each other. The base plate is adapted to be removably coupled with base of the mount and the sidewalls are adapted to be removably coupled with the electric motor.

In accordance with yet a further embodiment of the present disclosure a vehicle is disclosed. The vehicle comprises a frame, an electric motor including a motor housing and a pair of first engagement structure attached to an outer surface of the motor housing, and a bracket removably coupled to the pair of first engagement structures and the frame and removably coupling the electric motor to the frame.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a rear perspective view of a vehicle, in accordance with one embodiment of the present disclosure;

FIG. 2 illustrates a perspective view of a portion of the vehicle of FIG. 1 and depicting an electric motor assembly attached to a frame of the vehicle and including an electric motor and a bracket attaching the electric motor to the frame; and

FIG. 3 illustrates an exploded view of the portion of vehicle of FIG. 2, in accordance with one embodiment of the present disclosure.

### DETAILED DESCRIPTION OF EXEMPLARY EMBODIMENTS

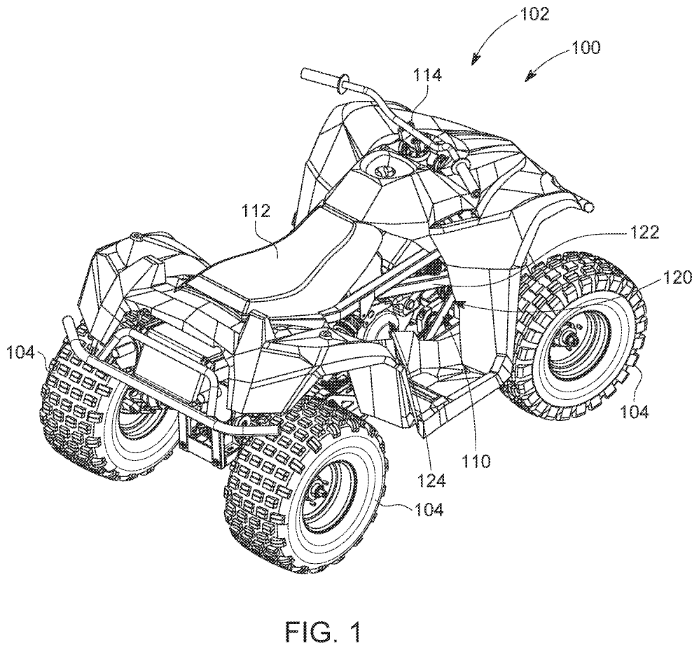

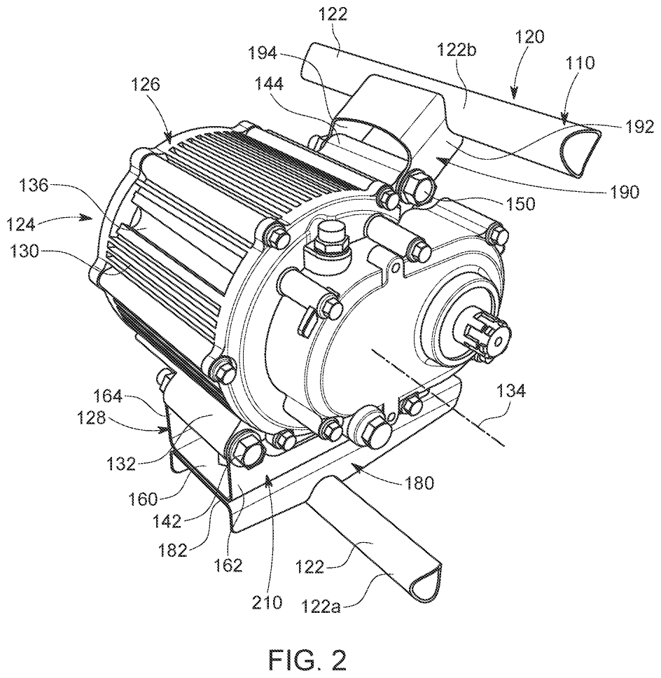

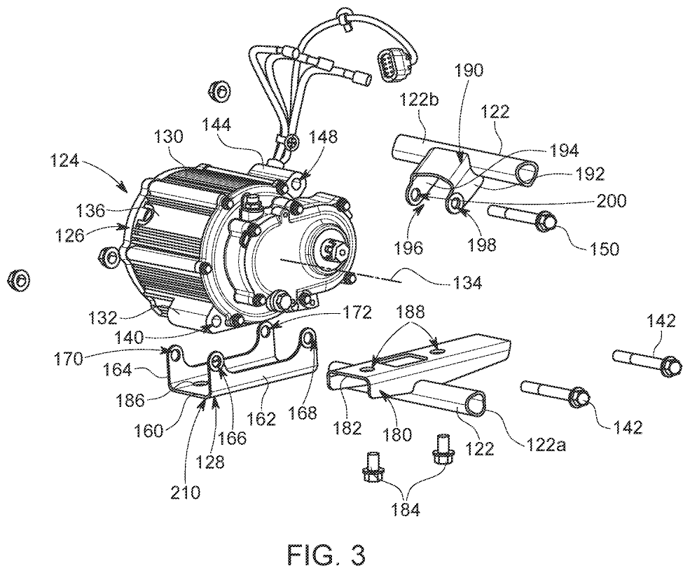

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-3, wherein like numbers indicate the same or corresponding elements throughout the views.

FIG. 1 illustrates a vehicle 100 according to an embodiment of the disclosure. In the illustrated embodiment, the vehicle 100 is shown as an electric all-terrain vehicle 102 having four wheels 104, however, it may be appreciated that vehicle 100 may be any other electric vehicle, for example, two wheeler, three wheeler or any other similar vehicle known in the art. The vehicle 100 includes a frame 110 for supporting various components of the vehicle 100 and the wheels 104 are connected to the frame 110, supporting the vehicle 100 on a surface and enables a movement of the vehicle 100 over the surface. Moreover, the vehicle 100 incudes a seat 112 supported on the frame 110 to enable a seating of one or more passengers on the vehicle 100, and a handle 114 to enable a driver to maneuver the vehicle 100. In illustrated embodiment, the frame 110 is a tubular frame 120 having a plurality of tubes 122 interconnected to one another, and the components of the vehicle, for example, the seat 112, the handle 114, the wheels 104, etc., are connected to one or more of the plurality of tubes 122.

Further, to power the vehicle 100 and rotate the wheels 104, the vehicle 100 includes at least one electrical motor assembly 124 having an electric motor 126 and a bracket 128 removably coupled to the electric motor 126. The bracket 128 facilitates the mounting of the electric motor 126 to the frame 110. To power the electric motor 126, the vehicle 100 also includes a battery electrically connected to the electric motor 126 and supported on the frame 110. The electric motor 126 and the bracket 128 are structured so as to facilitate a removable coupling with each other. To enable the engagement/coupling of the electric motor 126 with the bracket 128, the electric motor 126 includes a motor housing 130, and a pair of first engagement structures 132 connected to the motor housing 130 and extending in a direction substantially parallel to a central axis 134 of the motor housing 130 and arranged outwardly of an outer surface 136 of the motor housing 130. The first engagement structures 132 are arrayed along an arc of the motor housing 130 and are arranged spaced apart from each other. As shown, each of the first engagement structures 132 includes a substantially cylindrical shape defining an elongated hole 140 to enable the coupling of the electric motor 126 with the bracket via a first fastener 142.

Further, the electric motor 126 includes at least one second engagement structure 144 extending in a direction substantially parallel to the central axis 134 of the motor housing 130 and connected to the outer surface 136 of the motor housing 130. Similar to the first engagement structures 132, the second engagement structure 144 includes a cylindrical shape defining an elongated hole 148 that facilitates an engagement/coupling of the electric motor 126 with one of the tubes 122 of the frame 110 via a fastener 150.

Further, to enable the engagement of the electric motor 126 with the frame 110 i.e., tubes 122, the bracket 128 includes a base plate 160 and a pair of sidewalls 162, 164 extending substantially perpendicularly to the base plate 160. The sidewalls 162, 164 extend substantially parallel to and spaced apart from each other. It may be appreciated that a length of the bracket 128 corresponds to a distance between the two first engagement structures 132. As shown, the first sidewall 162 defines a first groove 166 and a second groove 168 extending through the first sidewall 162 and arranged, respectively, at a first end and a second end of the bracket 128. Similarly, the second sidewall 164 includes a first groove 170 and a second groove 172 extending through the second sidewall 164 and, respectively, arranged at the first end and the second end of the bracket 128. It may be noted that the first grooves 166, 170 of the sidewalls 162, 164 are arranged aligned with each other. Similarly, the second grooves 168, 172 of the sidewalls 162, 164 are also arranged aligned with each other. In the assembly of the electric motor 126 with the bracket 128, the electric motor 126 and the bracket 128 are arranged such that the first engagement structures 132 are arranged between the two sidewalls 162, 164 of the bracket 128, contacting the sidewalls 162, 164 such that the hole 140 of one of the first engagement structures 132 is arranged/disposed aligned with the first grooves 166, 170 of the sidewalls, while the hole 140 of other of the first engagement structures 132 is disposed aligned with the second grooves 168, 172 of the sidewalls 162, 164. Also, in the assembly one first fastener 142 extends through the first grooves 166, 170 and the aligned engagement structure 132, while another first fastener 142 extends through the second grooves 168, 172 and the aligned engagement structure 132.

Further, to enable the coupling of the bracket 128 with the frame 110 i.e., at least one tube, hereinafter referred to as at least one first tube 122a, a first mount 180 is attached to the at least one first tube 122a. In the illustrated embodiment, the first mount 180 is welded to a single first tube 122a, and includes a base 182 arranged to be attached to the base plate 160 of the bracket 128 via a pair of second fasteners 184. Also, in the engagement or attachment of the bracket 128 with the first mount 180, the base plate 160 of the bracket 128 abuts the base 182 of the first mount 180. To facilitate the attachment of the bracket 128 with the first mount 180 via the second fasteners 184, the base plate 160 defines a pair of slots 186 and the base 182 defines a pair of openings 188 that are arranged aligned with the pair of slots 186. In the assembly of the bracket 128 with the first mount 180, the second fasteners 184 extend through the aligned slots 186 and openings 188 and are attached to the base plate 160 and the base 182.

Additionally, the vehicle 100 includes a second mount 190 attached to the frame 110 i.e., a second tube 122b of the frame 110, and the second engagement structure 144 of the electric motor 126 is removably coupled to the second mount 190. As shown, the second mount 190 includes a pair of side plates 192, 194 arranged spaced apart from each other defining a gap 196. The side plates 192, 194 define aligned openings 198, 200 to enable the removable engagement of the second mount 190 with the second engagement structure 144 via the fastener 150. As shown, in the assembly of the electric motor 126 with the second tube 122b, the second engagement structure 144 is arranged inside the gap 196 with the side plates 192,194 contacting the ends of the second engagement structure 144 and the fastener 150 extending through the aligned openings 198, 200 and the aligned hole 148 of the second engagement structure 144. Also, the second mount 190 is welded to the second tube 122b. The bracket 128, the first mount 180, and the second mount 190 together define a mounting assembly 210 that enables a removable securing of the electric motor 126 to the frame 110 of the vehicle 100. The bracket 128 and hence the mounting assembly 210 effectively accommodates the electric motor 126 loading on the frame 110. Also, the bracket 128 improves the ease of assembly of the electric motor 126 to the frame 110 over a traditional, rigid mounted motor without pre-installed bracket.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended the scope of the disclosure be defined by the claims appended hereto.

What is claimed is:

1. An electric motor assembly for a vehicle having a frame, the electric motor assembly comprising:
an electric motor having a motor housing and a pair of engagement structures arrayed circularly around a circumference of the motor housing and attached to an outer surface of the motor housing; and
a bracket removably coupled to the pair of first engagement structures and adapted to be removably connected to the frame.

2. The electric motor assembly of claim 1, further includes at least one second engagement structure attached to the outer surface of the motor housing and adapted to be removably coupled with the frame.

3. The electric motor assembly of claim 1, wherein the bracket includes
a base plate defining a pair of slots to facilitate the removable coupling of the bracket with the frame, and
a pair of sidewalls extending from the base plate and arranged spaced apart from each other, wherein each of the pair of sidewalls defines a first groove and a second groove to enable the removable coupling of the bracket with the pair of first engagement structures.

4. The electric motor assembly of claim 3, wherein the pair of first engagement structures are arranged between the pair of sidewalls in an assembly of the electric motor with the bracket.

5. The electric motor assembly of claim 4, wherein one of the first engagement structures is arranged aligned with the first grooves of the sidewalls and another of the first engagement structures is arranged aligned with the second grooves of the sidewalls.

6. The electric motor assembly of claim 5, wherein each of the first engagement structures defines an elongated hole to facilitate a coupling of the first engagement structures with the sidewalls via first fasteners.

7. A mounting assembly for mounting an electric motor to a frame of a vehicle, the mounting assembly comprising:
a first mount attached to the frame and having a base; and
a bracket including a base plate and a pair of sidewalls extending from the base plate and arranged spaced apart from each other, wherein the base plate is adapted to be removably coupled with base of the mount and the sidewalls are adapted to be removably coupled with the electric motor.

8. The mounting assembly of claim 7, wherein the base of the first mount defines a pair of openings and the base plate defines a pair of slots arranged aligned with the pair of openings in the coupling of the base plate with the base.

9. The mounting assembly of claim 8, wherein a pair of second fasteners extends through the pair of openings and the pair of slots to couple the base plate with the base.

10. The mounting assembly of claim 7 further comprising a second mount attached to the frame and adapted to be removably coupled to the electric motor.

11. The mounting assembly of claim 10, wherein the second mount includes a pair of side plates arranged spaced apart from each and adapted to be removably coupled with the electric motor.

12. The mounting assembly of claim 11, wherein the pair of side plates are coupled with the electric motor via a fastener.

13. A vehicle, comprising:
a frame;
an electric motor including a motor housing and a pair of first engagement structure attached to an outer surface of the motor housing; and
a bracket removably coupled to the pair of first engagement structures and the frame and removably coupling the electric motor to the frame.

14. The vehicle of claim 13, wherein the bracket includes
a base plate defining a pair of slots to facilitate the removable coupling of the bracket with at least one of plurality of tubes, and
a pair of sidewalls extending from the base plate and arranged spaced apart from each other, wherein each of the pair of sidewalls defines a first groove and a second groove to enable the removable coupling of the bracket with the pair of first engagement structures.

15. The vehicle of claim 13, wherein the pair of first engagement structures are arranged between the pair of sidewalls and coupled to the sidewalls via first fasteners.

16. The electric motor assembly of claim 15, wherein one of the first engagement structures is arranged aligned with the first grooves of the sidewalls and another of the first engagement structures is arranged aligned with the second grooves of the sidewalls.

17. The vehicle of claim 14, wherein the frame is a tubular frame including a plurality of tubes connected to each other, wherein the bracket is removably coupled to at the least one of the plurality of tubes of the frame.

18. The vehicle of claim 17 further including
a first mount attached to the frame and having a base defining a pair of openings arranged aligned with the pair of slots of the base plate, and
a pair of second fasteners extending through the pair of openings and the pair of slots, removably coupling the base plate with the base.

19. The vehicle of claim 13, wherein
the electric motor includes at least one second engagement structure attached to the outer surface of the motor housing, and
the vehicle further includes a second mount attached to the frame and removably coupled to the at least one second engagement structure.

20. The vehicle of claim 19, wherein the second mount includes a pair of side plates arranged spaced apart from each other and are removably coupled to the at least one second engagement structure.
